(19) United States
(12) Patent Application Publication
(10) Pub. No.: US 2016/0067973 A1
(43) Pub. Date: Mar. 10, 2016

(54) METHOD OF CLEANING INK RESIDUES OFF AN INKJET HEAD

(71) Applicant: HEIDELBERGER DRUCKMASCHINEN AG, HEIDELBERG (DE)

(72) Inventor: BERNHARD BUCK, HEIDELBERG (DE)

(21) Appl. No.: 14/849,806

(22) Filed: Sep. 10, 2015

(30) Foreign Application Priority Data
Sep. 10, 2014 (DE) 102014013406.7

(51) Int. Cl. B41J 2/165

(52) U.S. Cl. CPC B41J 2/16552

(57) ABSTRACT

A method for cleaning ink residues off an inkjet print head includes applying a cleaning agent to a surface of the inkjet print head and then removing the cleaning agent from the surface. The surface has nozzle openings. The cleaning agent is applied to the surface as a gel, in particular as a gel that has a purely physical cleaning effect. This allows inkjet print heads to be cleaned in a simple way with very good results while avoiding the disadvantages connected with liquid cleaning agents, such as dripping off.

### CROSS-REFERENCE TO RELATED APPLICATION

This application claims the priority, under 35 U.S.C. §119, of German Patent Application DE 10 2014 013 406.7, filed Sep. 10, 2014; the prior application is herewith incorporated by reference in its entirety.

### BACKGROUND OF THE INVENTION

### Field of the Invention

The present invention relates to a method for cleaning ink residues off an inkjet print head, which includes applying a cleaning agent to a surface of the inkjet print head and removing the cleaning agent. The surface contains nozzle openings.

The invention belongs to the technical field of printing with inkjet print heads. Such print heads have to be cleaned from time to time to remove ink residues adhering thereto, in particular if nozzles are blocked or have failed (which is also referred to as “missing nozzles”).

The prior art in this technical field includes the following:

Cleaning devices and cleaning methods carried out by such cleaning devices are generally known. They use spraying nozzles, rubber lips, blowers and suction devices, cleaning cloths and residue containers.

It is also known to use ink for rinsing purposes. However, that cleaning process cannot remove solidified UV ink. Mechanical cleaning processes on the other hand are incapable of removing contamination within the nozzles and even risk washing further contamination into the nozzles. In some cases the sensitive nozzle surfaces may be damaged. The use of solvent-based chemical cleaning agents (containing solvents other than water) may affect the nozzle surfaces. In addition, such solvents are frequently considered to be health hazards. Another problem is that the nozzle surfaces usually point downward, causing a liquid cleaning agent to drip off too quickly without attaining its potential full cleaning effect.

German Patent Application DE 36 12 299 A1, corresponding to U.S. Pat. No. 5,237,341, discloses a cleaning method for print heads including the steps of collecting cleaning liquid and introducing it into an absorbent polymeric material, which then expands into a gel. In a similar way, U.S. Pat. No. 7,708,378 B2 proposes to collect ink residues and to solidify them into a gel. In both cases, the gel to be removed is in a collecting tank and no contact is envisaged between the gel and a nozzle surface of the head.

### SUMMARY OF THE INVENTION

It is accordingly an object of the invention to provide a method of cleaning ink residues off an inkjet head, which overcomes the hereinafore-mentioned disadvantages of the heretofore-known methods of this general type and which provides an improved method for allowing print heads to be cleaned in a simple way with very good results, in particular when UV-cured inks and nozzle surfaces that point downward are used.

With the foregoing and other objects in view there is provided, in accordance with the invention, a method for cleaning ink residues off an inkjet head in which a cleaning agent is applied to and removed from a surface of the head. The surface contains nozzle openings and the cleaning agent is applied to the surface as a gel.

In the context of the present invention, the term “gel” is to be understood to refer to a system of a gelatinous texture (rather solid than liquid) and of a finely dispersed structure formed of at least one solid phase and one liquid phase. The solid phase forms a sponge-like three-dimensional net having pores which are filled by a liquid or gas.

The method of the invention advantageously allows print heads to be cleaned in a simple way with very good results. Even nozzle surfaces that are contaminated by dried/solidified UV ink may effectively be cleaned in an advantageous way. Likewise in an advantageous way, it is possible to apply the cleaning agent for a defined soaking time to downward-pointing nozzle surfaces without any cleaning agent dripping off. In addition, damage to the print head due to a mechanical influence is advantageously avoided.

In accordance with the invention, the cleaning agent is already applied to the nozzle surface as a gel and not as a liquid. This feature differentiates the invention from the prior art, in which a liquid is applied and removed and only subsequently jelled (i.e. not on the nozzle surface).

The method of the invention may be carried out on print heads that are installed in a printing machine. Alternatively, the method may be carried out outside the machine on dismounted heads in a separate cleaning unit.

Advantageous and thus preferred further developments of the invention will become apparent from the associated dependent claims and from the description and the associated drawings.

In accordance with another preferred mode of the invention, the gel remains on the surface for a period of time between application and removal to produce its effect.

In accordance with a further preferred mode of the invention, the period of time may range between approximately 1 second and approximately 10 minutes, in particular between approximately 10 seconds and approximately 3 minutes. Such a soaking time is advantageous in particular in connection with the use of gels that have a purely physical effect, as explained in the following two paragraphs.

In accordance with an added preferred mode of the invention, the gel is a gel that substantially has a purely physical cleaning effect and removes ink residues adhering to the surface and/or located in the nozzles (or ducts thereof) in particular by physically undermining/crawling/infiltrating under the residues. The physical cleaning effect may be assisted by ultrasound. In accordance with an added preferred mode of the invention, the gel may not contain any solvent other than water.

Examples of gels that clean by using physical effects are “intelligent fluids”® or “lisoCLEAR”® manufactured by Bubbles and Beyond GmbH in Leipzig, Germany. According to the manufacturer, these products penetrate deeply into pollution or contamination, diffuse through and underneath layers of ink and dirt and lift them quickly and thoroughly off the surface to be cleaned without any residue. The process does not involve any chemical solvents or etching processes and does not cause smearing of the surfaces (see www.intelligent-fluids.de, under the “Industrial Cleaning” heading).

In accordance with an additional preferred mode of the invention, the gel is provided in a cap that is moved close to the surface or is brought into contact with the surface (in a marginal region thereof, but not in the nozzle region). The cap is moved, preferably up and down, for this purpose. Alternatively, the head may be moved in the direction of the cap. After the last print or during an extended interruption of the printing process, for instance overnight, the cap containing the gel may remain on the nozzle surface (which is also referred to as “capping”). In this case, the cap acts to prevent the ink and gel from drying. Since the invention proposes to use a gel instead of a liquid, the cleaning agent is advantageously prevented from leaking from the cap, for instance during prolonged storage or movement of the cap.

In accordance with yet another preferred mode of the invention, the gel is applied to the surface by using a blade or a roller, which may also be used to remove the gel if necessary or desired. As a further alternative, the gel may be applied by a nozzle, in particular a slot nozzle, that is moved past the head at a distance. It is also possible, albeit more complex in constructional terms, to integrate nozzles for the gel into the head. A further step might be to place a gel pad on the nozzle surface for the aforementioned period of time. Gel pads may be supplied and removed by using the cap.

In accordance with yet a further preferred mode of the invention, the head is controlled in such a way that ink is moved in at least one nozzle, in particular that the ink is moved back and forth. In accordance with yet an added preferred mode of the invention, the head is controlled in such a way that the gel is sucked into at least one nozzle. In this way, the gel may be introduced into the nozzles, where it may produce its physical effect on potential clogs. However, no expelling of ink is envisaged. It is only the column of ink in the nozzle duct and the ink meniscus thereof, i.e. the interface between ink and atmosphere, that is to be moved to “pump” the gel back and forth.

In accordance with yet an added preferred mode of the invention, the gel and ink residues are dabbed, sucked and/or rinsed off the surface. Rinsing with ink is also advantageous. A drying process may follow.

The invention as such as well as advantageous further developments of the invention will be described in more detail below with reference to the associated drawings and based on at least one preferred exemplary embodiment. In the drawings, like elements bear like reference symbols.

With the objects of the invention in view, there is also provided a device for carrying out the method. The device comprises a gel-filled cap that is movable close to or engaged with the nozzle surface. Such a device may interact with a number of heads by being moved to different cleaning positions.

With the objects of the invention in view, there is concomitantly provided an inkjet printing machine including at least one such device for carrying out the method.

Other features which are considered as characteristic for the invention are set forth in the appended claims.

Although the invention is illustrated and described herein as embodied in a method of cleaning ink residues off an inkjet head, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a group of three diagrammatic, vertical-sectional views of a device as it carries out a preferred embodiment of the method according to the invention; and

FIG. 2 is a vertical-sectional view of a further device as it carries out a preferred embodiment of the method according to the invention.

### DETAILED DESCRIPTION OF THE INVENTION

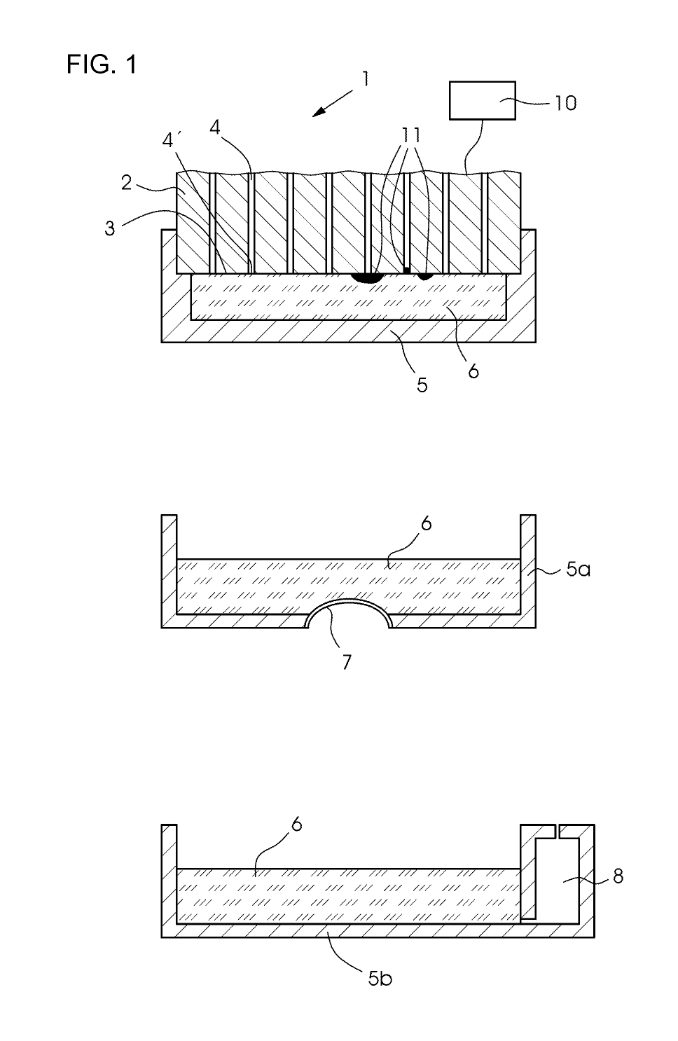

Referring now to the figures of the drawings in detail and first, particularly, to FIG. 1 thereof, there is seen a device 1 as it carries out a preferred embodiment of the method of the invention. The implemented method is carried out to clean ink residues 11 off an inkjet print head 2, preferably a print head 2 for printing with UV ink. A cleaning agent is applied to and removed from a surface 3 of the head. The surface 3 has nozzles 4 with downward-pointing nozzle openings 4′. The ink residues may have solidified and they may adhere to the surface and/or clog the nozzle openings.

The device 1 includes a cap 5 that is moved close to the surface 3 or brought into contact with the surface (preferably in an automated way). A mechanical stop may be provided to prevent the bottom surface of the cap from contacting the nozzle surface 3. A gel 6 to be applied to the surface as a cleaning agent is provided in the cap 5. The gel is thus brought into contact with the surface 3 and the nozzle openings 4′. Gel is preferably applied to the entire surface.

Once the cap 5 containing the gel 6 has at least been moved close to the surface 3, the cap remains in the cleaning position for a defined period of time. During this period, the gel may produce its physical effect. Thereafter, the cap is moved out of the cleaning position together with the gel. Gel residues and ink residues 11 that have been cleaned off are dabbed, sucked and/or rinsed off with water. A rinsing with ink may follow.

FIG. 1 additionally shows an alternative cap 5a that has a compensation membrane 7, which allows the cap containing the gel 6 to be engaged with the surface 3 under a desired pressure. The membrane carries out a compensatory movement. FIG. 1 further shows an alternative cap 5b that has a compensation chamber 8, which is not filled with gel before the cap is placed on the head 2. As a result, the chamber also allows the cap containing the gel 6 to be engaged with the surface 3 at a desired pressure since the chamber may fill with gel. Both embodiments prevent the gel from being pressed through the gap between the surface 3 and the cap.

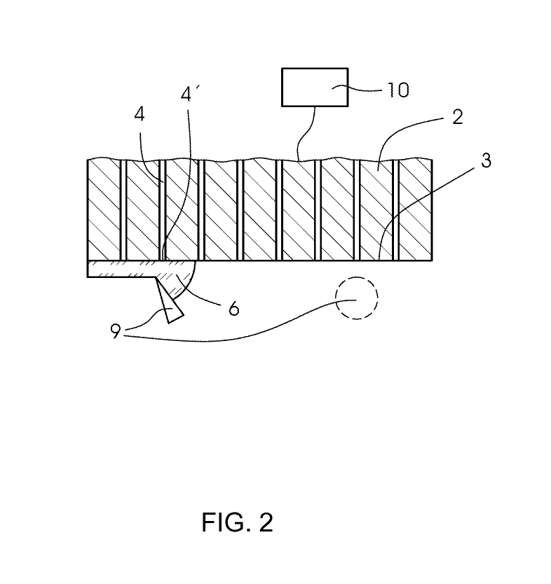

FIG. 2 illustrates a further device 1 as it carries out a preferred embodiment of the method of the invention. The device includes a doctor blade 9 or, alternatively, a (dashed-lined) roller for applying the gel 6 to the surface 3.

Both figures illustrate a control unit 10 that controls the print head 2. The control unit allows the ink in the nozzles to be moved and in particular allows an ink column and the meniscus thereof in the region of the nozzle opening 4′ to be moved back and forth. In this way, the gel 6 may be sucked into and expelled again from the nozzle opening due to the movement of the ink. The actuation may be done in accordance with a waveform that has been provided specifically for this purpose. No ink is expelled in the process.

1. A method for cleaning ink residues from an inkjet print head, the method comprising the following steps:
providing the inkjet print head with a surface containing nozzle openings;
applying a cleaning agent as a gel to the surface of the inkjet print head; and
removing the cleaning agent.

2. The method according to claim 1, which further comprises keeping the gel on the surface for a period of time between the applying step and the removing step to produce an effect.

3. The method according to claim 2, wherein the period of time is in a range between approximately 1 second and approximately 10 minutes.

4. The method according to claim 2, wherein the period of time is in a range between approximately 10 seconds and approximately 3 minutes.

5. The method according to claim 1, wherein the gel has a substantially purely physical cleaning effect and removes the ink residues adhering to the surface.

6. The method according to claim 5, wherein the gel removes the ink residues by undermining or infiltrating.

7. The method according to claim 5, wherein the gel does not contain any solvent other than water.

8. The method according to claim 1, which further comprises:
providing the gel in a cap; and
moving the cap close to the surface or bringing the cap into contact with the surface.

9. The method according to claim 1, which further comprises carrying out the step of applying the gel to the surface by using a blade or a roller.

10. The method according to claim 1, which further comprises controlling the inkjet print head by moving ink in at least one nozzle.

11. The method according to claim 10, which further comprises moving the ink back and forth in the at least one nozzle.

12. The method according to claim 10, which further comprises controlling the inkjet print head by sucking the gel into the at least one nozzle.

13. The method according to claim 1, which further comprises at least one of dabbing, sucking or rinsing the gel and the ink residues off the surface.
